(19) United States
(12) Patent Application Publication
(10) Pub. No.: US 2025/0353131 A1
(43) Pub. Date: Nov. 20, 2025

(54) TOOL ARRANGEMENT, IN PARTICULAR GRINDING ARRANGEMENT

(71) Applicant: KAPP NILES GmbH & Co. KG, Coburg (DE)

(72) Inventors: Sergiy GRINKO, Coburg (DE); Nico SCHILLING, Lautertal (DE); Achim STEGNER, Coburg (DE); Lars LUTHER, Meeder (DE); Holger ARMBORST, Sonneberg (DE); Julian GLEICHMANN, Meeder (DE)

(21) Appl. No.: 19/207,613

(22) Filed: May 14, 2025

(30) Foreign Application Priority Data
May 16, 2024 (DE) 10 2024 113 823.8

(51) Int. Cl. B24B 23/02; F16J 15/447

(52) U.S. Cl. CPC B24B 23/02; F16J 15/447

(57) ABSTRACT

A tool arrangement, including a tool spindle having a fixed first part and a second part rotatably mounted relative to the first part. The second part carries a tool. A drive motor having a stator and a rotor rotates the second part relative to the first part. The first part is formed by the stator and the second part is formed by the rotor. The stator includes a first bearing that supports the rotor at a first axial position and a second bearing that supports the rotor at a second axial position. The first bearing has an inner ring arranged on the outer circumference of the stator, and an outer ring arranged on an inner cylindrical surface of the rotor. The second bearing has an outer ring arranged on an inner cylindrical surface of the stator and an inner ring arranged on an outer cylindrical surface of a cover that is connected to the rotor.

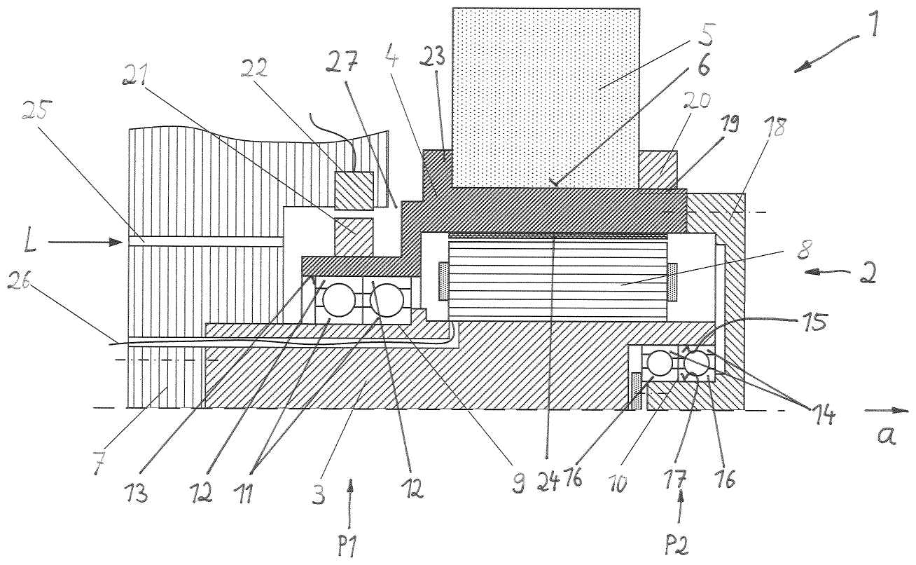

### CROSS-REFERENCE TO RELATED APPLICATIONS

The present application claims priority of DE 10 2024 113 823.8, filed May 16, 2024, the priority of this application is hereby claimed, and this application is incorporated herein by reference.

### BACKGROUND OF THE INVENTION

The invention relates to a tool arrangement, in particular grinding arrangement, comprising a tool spindle having a fixed first part and a second part which is rotatably mounted relative to the first part, wherein the second part carries a tool, in particular a grinding tool, wherein a drive motor having a stator and a rotor being arranged to rotate the second part relative to the first part, wherein the first part of the tool spindle is formed by the stator of the drive motor, wherein the second part is formed by the rotor of the drive motor, wherein a seat for the tool is formed on the outer circumference of the rotor, wherein the stator extends in an axial direction and at least one first bearing is arranged at a first axial position and at least one second bearing is arranged at a second axial position, and wherein the two bearings rotatably support the rotor relative to the stator.

A grinding arrangement of the generic type is described in DE 10 2006 009 786 A1. A drive motor drives the tool spindle, with the rotating part of the tool spindle carrying the grinding tool. In order to achieve a compact design, the solution mentioned here already provides for the motor rotor to be designed directly as a holder for the grinding tool.

Further similar solutions are disclosed in DE 10 2009 038 223 A1 and in WO 2005/056195 A1.

When grinding internal gears or profiles, the tool spindle is often arranged on or in a grinding arm. In most cases, the problem arises that the tool spindle is to be accommodated in a very confined space. A solution with a grinding arm is described, for example, in EP 0 416 151 A1. The tool spindle is arranged in the axial end area of a tubular grinding arm, with the drive motor being positioned in the other axial end area of the grinding arm. The torque of the drive motor is transmitted to the tool spindle via a belt drive. A similar solution is shown in DE 10 2016 012 915 A1.

In the case of tool spindles of a conventional design, the machining loads or the forces that arise due to unbalance are usually supported by a corresponding bearing, which is sometimes located relatively far away from the tool holder. Therefore, counter bearings are often used here to provide additional support. One such solution is also described in the aforementioned DE 10 2006 009 786 A1, in which the relatively long stator is supported by two widely spaced bearings.

Furthermore, large distances and joints have a negative effect on the mechanical transmission paths between a required measuring system, the drive torque introduction and the machining load introduction (at the location of the tool). This results in a disadvantageous static and dynamic flexibility due to the necessary separation points.

Therefore, in the case of such tool spindles of classic design, the assessment of the loads applied, for example by evaluating the motor current, is just as problematic as the precise measurement of the position of the spindle and the recording of further data. Also, the assessment of the vibration behaviour and the recording of vibration amplitudes becomes difficult due to the relatively long mechanical transmission distances.

### SUMMARY OF THE INVENTION

The underlying problem of the invention is to develop a grinding arrangement of the type mentioned above in such a way that an even more compact unit is created than in the previously known solution, which is particularly suitable for generating grinding. Accordingly, it should be possible to precisely detect and control the movements of the tool. Nevertheless, a high motor power is aimed for. The aim is to achieve a design that, on the one hand, requires only a small amount of space and, on the other hand, can be realised with relatively few parts so that cost-effective production is possible. This should enable highly productive generating machining, especially of internal gears under practical conditions. Furthermore, sufficient space should be available for the windings of the motor.

The solution of this problem by the invention is characterised in that the first bearing has at least one inner ring, which is arranged on the outer circumference of the stator, and at least one outer ring, which is arranged on an inner cylindrical surface of the rotor, wherein the second bearing has at least one outer ring which is arranged on an inner cylindrical surface of the stator, and at least one inner ring, which is arranged on an outer cylindrical surface of a cover that is connected to the rotor.

“Inner” means that the normal to the surface points radially inwards; “outer” means that the normal to the surface points radially outwards.

Preferably, it is provided that the cover is connected to the at least one inner ring of the second bearing and to the rotor and is otherwise free of a connection to a further machine part, so that the rotor is mounted in an overhung manner on the stator.

The stator is preferably fixedly connected to the end region of a rod- or tube-shaped grinding arm.

Mostly, at least one current-carrying motor winding is arranged on the outer circumference of the stator.

The bearings (first and/or second bearing) preferably comprise (each) two angular contact ball bearings; the two angular contact ball bearings are arranged in particular in an O-arrangement.

The rotor may have a thread in the area of the seat for the grinding tool for the purpose of receiving a clamping nut. Alternatively, another type of attachment and, in particular, axial clamping of the grinding tool on the rotor can, of course, be provided (e.g. by means of screws).

The tool arrangement preferably includes a position or rotary encoder which has a measuring scale arranged on the rotor and at least one reading head arranged on the stator or on a component connected to the latter, in particular on the grinding arm. The position or rotary encoder is preferably arranged at the above-mentioned first axial position or adjacent to it.

The area between the tool (or a flange-shaped section of the rotor, which forms an axial stop for the tool) and the grinding arm has also proven to be a favourable location for the position or rotary encoder.

The cover mentioned above reliably seals the entire arrangement in one axial end area of the tool. In order to prevent the ingress of media in the other axial end area of the tool as well, a preferred further embodiment provides that a seal is arranged between the grinding arm and the rotor. It is particularly preferred that the seal is designed as a barrier air seal or as a labyrinth seal.

This design ensures both a stable (overhung) mounting of the rotor relative to the stator (i.e. without a counter bearing) and a well-sealed unit that has a compact design.

The seal between the grinding arm and the rotor mentioned above can be used to achieve a reliable seal for the entire tool assembly with only one sealing point.

The stator of the drive motor is advantageously mounted in such a way that at least one bearing (namely the second bearing mentioned above) is arranged inside the stator shaft with a fixed outer ring or outer rings, wherein the rotor receptacle with the stator shaft is connected in an encapsulating manner to a cover element by the second bearing.

Thus, the proposal provides a grinding device and, in particular, a grinding arm that is favoured for grinding internally toothed components or components with internal profiles (although, of course, externally toothed components or components with external profiles can also be machined), in which a directly driven motor in the form of an external rotor is used, which is preferably equipped with a measuring system for motor control or feed-back control. The rotor of the motor is used directly as a tool holder for a grinding worm or a grinding disc.

The proposed grinding arrangement is used primarily in internal grinding, where a grinding worm is used as the grinding tool to grind an internal profile. The advantage of this is that the tool is driven directly close to the grinding point, which allows for precise rotation of the tool, which plays a particularly important role in generating grinding.

The invention provides a relatively small, yet powerful motor to directly drive the grinding tool, which is particularly suitable for machining the gearing into internally geared workpieces. In particular, the following functions are provided by arranging the corresponding components:

The grinding tool holder is designed to allow for quick tool changes.

A position encoder (consisting of a measuring scale and a reading head) can be used to detect the exact rotational position of the tool and control it accordingly, which is particularly important for generating grinding.

A structure-borne sound sensor can be integrated to simplify the set-up of the grinding process and enable system monitoring.

The bearing used to hold the rotor relative to the stator can be provided with appropriate lubrication (including lifetime lubrication if necessary).

Measures for dissipating power loss can be integrated.

The system is resistant to the effects of the medium (grinding oil) required for the machining, in particular due to the arrangement of the corresponding seals.

The arrangement provides sufficient mechanical power, which is possible despite the compact design.

The proposed concept enables highly dynamic control and thus precise production of the gearing and profile. This makes it possible to achieve highly dynamic axes, which in turn delivers better machining results. The measurement close to the point of action allows a better correlation between measurement and actual vibration amplitude at the gearing.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

The drawing shows an embodiment of the invention. The single FIGURE shows a radial section through the end of a grinding arm on which a driven grinding spindle and a grinding tool are arranged.

### DETAILED DESCRIPTION OF THE INVENTION

The FIGURE shows the end area of a rod- or tube-shaped grinding arm 7 (only indicated). In the end area of the grinding arm 7, a tool spindle 2 is arranged, which carries a grinding tool 5 in the form of a grinding worm. This forms a grinding arrangement 1.

The tool spindle 2 consists of a first part 3 and a second part 4. The first part 3 is firmly connected to the grinding arm 7 and is designed as a stator for the drive motor of the tool spindle 2. The second part 4 is supported so that it can rotate relative to the first part 3 and is designed as a rotor for the drive motor of the tool spindle 2. For this purpose, the outer circumference of the rotor 4 has a cylindrical seat 6, which is designed to receive the grinding worm 5.

In order for the grinding worm 5 to be mounted securely and axially clamped on the rotor 4, in the embodiment the outer circumference of the rotor 4 has a thread 19 onto which a clamping nut 20 can be screwed in order to clamp the grinding worm. For this purpose, the rotor 4 has a flange-shaped widened section 23, which serves as an axial contact surface for the grinding worm 5.

As an alternative to the clamping nut, other solutions can of course be provided for fixing the grinding worm 5 to the rotor 4, in particular a screw connection with screws whose longitudinal axis runs in the axial direction a.

A motor winding 8 is arranged on the stator 3 to generate the drive torque when a current flows through the motor winding 8. A number of magnets 24 are arranged on a radially inner surface of the rotor 4.

The mounting of the rotor 4 relative to the stator 3 is designed in a special way to advantageously create a compact and sealed unit. For this purpose, a first bearing 9 and a second bearing 10 are provided, which are arranged along the axial direction a at a first position P1 and at a second position P2, respectively. In the embodiment shown, both bearings 9 and 10 each consist of two angular contact ball bearings that are arranged adjacent to one another in an O-arrangement.

The rotor 4 has an internal cylindrical surface 13, against which the outer rings 12 of the first bearing 9 rest. The inner rings 11 of the first bearing 9 are mounted on the outer circumference of the stator 3.

The end of stator 3 facing away from the grinding arm 7 has a recess that forms an internal cylindrical surface 15. The outer rings 14 of the second bearing 10 rest against this. The connection between the stator 3 and the rotor 4 is produced here by means of a cover 18, which has in its radially inner region an outer cylindrical surface 17, which receives the inner rings 16 of the second bearing 10. In the radially outer region of the cover 18, this is screwed to the rotor 4.

Since the grinding arrangement 1 is to be used in particular for generating grinding of an internal gearing, the exact rotational position of the grinding worm 5 during machining is of particular importance, as this must be coordinated with the rotation of the workpiece (not shown) to be machined.

To achieve this in a precise manner, a position or rotary encoder 21, 22 is attached to the rotor 4, which in the embodiment is placed at the location of the first axial position P1. At least one reading head 22 is mounted in the grinding arm 7, forming an air gap, which detects a measuring scale 21 so that the exact rotational position of the rotor 4 can be determined. The measuring scale can be arranged on the rotor as a separate component or it can also be incorporated into the rotor (e.g. as a laser engraving).

Thus, the grinding assembly 1 forms a directly driven grinding spindle, whereby the drive motor used is an external rotor motor.

The drive torque is applied directly to the external rotor, which carries the tool, in this case the grinding worm 5.

This is a direct linear mechanical transmission path for the introduction of the motor torque to the workpiece (and thus to the machining load). This helps to avoid non-linearities in the transmission of the torque to the workpiece; furthermore, there is only a small static and dynamic resilience.

The measuring scale 21 for the position measuring system, which is arranged or mounted directly on the rotor 4, is also advantageous due to the close connection to the tool 5 and allows a very direct measurement. The measuring system is therefore mounted directly on the externally rotating rotor 4 and can thus measure the rotor position and thus the tool position directly.

Reliable sealing of the grinding arrangement 1 is ensured by the cover 18 in one axial end area of the tool 5. In the other axial end area (in the area of the flange-shaped section 23), sealing is achieved by means of a seal 27. In the embodiment shown, this is implemented by means of sealing air (air L), whereby the air L is supplied via the sealing air channel 25, so that a reliable seal is also present here. Alternatively or additionally, the seal 27 can also be provided, for example, by a (not shown) labyrinth seal.

The electrical supply to the motor winding 8 is provided by a power line 26, which runs in a suitably designed channel.

The proposed direct drive of the grinding tool 5 with corresponding spindle bearing in the external rotor design, in particular, offers the following advantages:

An improved rolling coupling between tool and workpiece can be realised, which is favoured by an undisturbed control; this results from the favourable mechanical transmission path.

There is a high rigidity with regard to machining loads, which is achieved in particular by the favourable bearing arrangement and positioning mentioned above. In this regard, a counter bearing is not required, which is the result of the load introduction to the proposed bearing.

This results in a very compact design for the grinding assembly with direct tool reception.

A measurement close to the point of action allows an improved assessment of the vibration excitation in the gear area.

The grinding arrangement requires relatively few components and can therefore be manufactured cost-effectively.

The design also enables greater dynamics and a more dynamic motor control.

When mounting the grinding arrangement, the completely pre-assembled stator 3 can be placed in the grinding arm and specifically in a recess provided there. Then the stator 3 is screwed to the grinding arm 7 (see screw axis below the power line 26 in the FIGURE).

While specific embodiments of the invention have been shown and described in detail to illustrate the inventive principles, it will be understood that the invention may be embodied otherwise without departing from such principles.

List of References:

| | |
|---|---|
| 1 | Grinding arrangement |
| 2 | Tool spindle |
| 3 | First part of the tool spindle (stator) |
| 4 | Second part of the tool spindle (rotor) |
| 5 | Grinding tool (grinding worm) |
| 6 | Seat for the grinding tool |
| 7 | Grinding arm |
| 8 | Motor winding |
| 9 | First bearing |
| 10 | Second bearing |
| 11 | Inner ring or inner rings of the first bearing |
| 12 | Outer ring or outer rings of the first bearing |
| 13 | Inner cylindrical surface of the rotor |
| 14 | Outer ring or outer rings of the second bearing |
| 15 | Inner cylindrical surface of the stator |
| 16 | Inner ring or inner rings of the second bearing |
| 17 | Outer cylindrical surface of the cover |
| 18 | Cover |
| 19 | Thread |
| 20 | Clamping nut |
| 21,22 | Position encoder/rotary encoder |
| 21 | Measuring scale |
| 22 | Reading head |
| 23 | Flange-shaped section |
| 24 | Magnet |
| 25 | Sealing air channel |
| 26 | Power line |
| 27 | Seal |
| a | Axis direction |
| P1 | First axial position |
| P2 | Second axial position (different from |
| | the first axial position) |
| L | Air |

We claim:

1. A tool arrangement, in particular grinding arrangement, comprising a tool spindle having a fixed first part and a second part which is rotatably mounted relative to the first part, wherein the second part carries a tool, in particular a grinding tool, wherein a drive motor having a stator and a rotor being arranged to rotate the second part relative to the first part, wherein the first part of the tool spindle is formed by the stator of the drive motor, wherein the second part is formed by the rotor of the drive motor, wherein a seat for the tool is formed on the outer circumference of the rotor, wherein the stator extends in an axial direction and at least one first bearing is arranged at a first axial position and at least one second bearing is arranged at a second axial position, and wherein the two bearings rotatably support the rotor relative to the stator, wherein the first bearing has at least one inner ring, which is arranged on the outer circumference of the stator, and at least one outer ring, which is arranged on an inner cylindrical surface of the rotor, wherein the second bearing has at least one outer ring which is arranged on an inner cylindrical surface of the stator, and at least one inner ring, which is arranged on an outer cylindrical surface of a cover that is connected to the rotor.

2. The tool arrangement according to claim 1, wherein the cover is connected to the at least one inner ring of the second bearing and to the rotor and is otherwise free of a connection to a further machine part, so that the rotor is mounted in an overhung manner on the stator.

3. The tool arrangement according to claim 1, wherein the stator is fixedly connected to the end region of a rod- or tube-shaped grinding arm.

4. The tool arrangement according to claim 1, wherein at least one current-carrying motor winding is arranged on the outer circumference of the stator.

5. The tool arrangement according to claim 1, wherein the first bearing and/or the second bearing comprises two angular contact ball bearings, wherein the two angular contact ball bearings are preferably arranged in an O-arrangement.

6. The tool arrangement according to claim 1, wherein the rotor has a thread in the region of the seat for the tool especially for the grinding tool, for receiving a clamping nut.

7. The tool arrangement according to claim 1, wherein it comprises a position or rotation encoder which has a measuring scale that is arranged on the rotor, and at least one reading head that is arranged on the stator or on a component connected to it, in particular on the grinding arm.

8. The tool arrangement according to claim 7, wherein the position or rotation encoder is arranged at the first axial position or adjacent thereto.

9. The tool arrangement according to claim 3, wherein a seal is arranged between the grinding arm and the rotor.

10. The tool arrangement according to claim 9, wherein the seal is designed as a sealing air seal or as a labyrinth seal.
